(19) United States
(12) Patent Application Publication
(10) Pub. No.: US 2005/0169704 A1
(43) Pub. Date: Aug. 4, 2005

(54) Mortise and tenon joint

(76) Inventors: Alan Vu, Westbrook, CT (US); Gregory Budzian, New Britain, CT (US); Arthur D. Ritone JR., Newington, CT (US)

Correspondence Address: SILLS CUMMIS EPSTEIN & GROSS P.C., ONE RIVERFRONT PLAZA, IP DEPARTMENT, NEWARK, NJ, 07102, US

(21) Appl. No.: 11/035,664

(22) Filed: Jan. 14, 2005

Related U.S. Application Data
(60) Provisional application No. 60/481,912, filed on Jan. 16, 2004.

(51) Int. Cl. B25G 3/00

(52) U.S. Cl. 403/401

(57) ABSTRACT

The invention provides a joint and a method for forming a joint between two structural elements comprising a tenon on a mitered edge of a first structural element joined to an oppositely corresponding mortise on a mitered edge of a second structural element.

### CROSS REFERENCE TO RELATED APPLICATIONS

The present application is a non-provisional application claiming the benefit of prior U.S. Provisional Application No. 60/481,912, filed Jan. 16, 2004.

### FIELD OF THE INVENTION

This invention relates generally to structural systems and a joint for joining structural elements together as a building material. More particularly, the joint is for trim moulding or stationary framework that is mitered on opposite ends to form a mortise or tenon.

### BACKGROUND OF THE INVENTION

Many types of joints for structural elements exist. A simple butt joint is formed by nailing or screwing two ends together. This joint is formed by nailing or screwing the end of one piece of wood to the end of the other. While this is simple, fast and effective, the butt joint cannot be used on many types of end joints since it is not strong. A simple butt joint also leaves the heads of the fasteners exposed which is often undesirable.

Another type of joint is the end lap joint. This joint is made by removing substantially halfway through each piece of structural element. That is, chamfering the ends of structural elements, and securing them together. Typically, the ends are glued with an adhesive or fastened together with a fastener. This is a common type of joint used in picture frames. The problem with this type of joint is that it does not withstand shear forces very well, and any force on the structure will impart shear forces on the joint. Glued joints of this type are also weak due to the shear forces.

A rabbet joint has become a standard design for many applications that utilize extended tab and pocket cutout joinery. In a rabbet joint, the pocket cutouts are at the very edge of the panel, with the pocket sidewalls actually incorporated into the outer edge of the panel.

Rabbet joints are commonly found in simple box and case construction. A rabbet is typically an L-shaped groove cut across the edge or end of one structural element. Fitting the other piece into it makes the joint. The rabbet joint is usually fastened with glue and nails or screws. This type of joint permits joint location to occur at the edge of a panel, thus providing the benefit of a non-interfering edge profile. The disadvantage of the rabbet joint, is that the joint must be adhesive bonded to secure the panel connection, and the primary load path is through the relatively weak adhesive bondline at the rabbet joint.

The dado is used to provide a supporting ledge for a shelf. The dado is a groove cut across the grain. In the simple dado joint, the butt end of the piece or shelf fits into this groove. The problem with this joint is that, unless a face frame is added to the front of the case, it has an unattractive look. For better appearance, a stopped or blind dado is the very best. In this joint, a dado is cut partway across the first piece, and then a corner is notched out of the second piece so the two fit together.

An alternate to the joint mentioned is referred to as a mortise and tenon joint. To form this joint, a slot is placed in one structural element. The end of the other structural element is then notched out to correspondingly fit the slot in the first piece. One inserts the notched piece into the slotted piece of the structural element. An open mortise and tenon joint is made by cutting the slot or mortise only partway into the structural element. Then create a notched-out area on the other piece that correspondingly fits into the slotted area in the first piece.

The bonding process of a mortise and tenon joint may involve applying adhesive into the mortise pocket, however, since the pocket is fully enclosed in the mortise panel (not incorporated into the panel edge as in the rabbet joint), the primary load path is through the mortise panel itself and not the adhesive bondline. The disadvantage of the mortise and tenon joint is the existence of an edge margin of the mortise panel that extends from the mortise pocket to the actual edge of the panel. This interfering edge margin reduces the volume which can be achieved inside a defined envelope.

Typically, relatively large clearances must be designed into mortise and tenon joint interfaces so that costly interference conditions do not occur, preventing the tenon tabs from fitting into the mortise pockets, and resulting in the scrapping of parts or expensive rework. These large clearances between the mortise pocket sidewalls and the tenon tab surfaces, increase the need for elaborate and expensive tooling to accurately locate and secure the panels. While the panels are held in place, an adhesive, which is used to bond the joint, is allowed the necessary time to cure. A joint structure with inherent self-tooling features that could eliminate the need for expensive additional tooling is highly desirable.

### SUMMARY OF THE INVENTION

This invention provides an improved mortise and tenon joint. The joint is a stopped or blind mortise and tenon joint where the tenon is hidden fully in the mortise. In the preferred embodiment of the present invention, a first and second trim moulding is constructed as a mortise and tenon. In the preferred embodiment, the tenon is perpendicular to the miter edge. The tenon preferably has a thickness of approximately ⅓ that of the moulding at the middle of the miter. The width is approximately ½ the width of the joint. The height is approximately equal to the mortise depth and preferably less approximately ¼ inch.

The tenon has a glue relief on the back side. In the preferred embodiment, the tenon is produced on the vertical side of the trim, but can be produced on the horizontal as well. The mortise can be produced on the vertical or horizontal as well. By consistently producing the mortise in one configuration and the tenon in the other, identifying the vertical and horizontal structural elements is easier. The mortise is designed to receive the tenon in a tight, close fit such that the friction between the mortise and tenon hold the structural elements together under the expected stress and forces. The depth of the mortise may vary depending on the materials, design preferences, strength desired as well as other factors. Preferably it is designed to come within ¼ inch of the outside surface of the finish moulding, and thus is unique to a particular size and style of moulding.

The purpose of the mortise and tenon on the miter of the vertical and horizontal joining of the structural elements is: (1) to maximize the surface area of contact in the joining; (2) to assure that the joining parts do not move independently of each other; and (3) to assure the precise alignment in the joining of the mitered edges to produce a quality joint by the end user at the time of application with minimal amount of skill and time.

### BRIEF DESCRIPTION OF THE DRAWINGS

FIG. 1 is a plan view of a tenon of the present invention;

FIG. 2 is an elevational view of a tenon of the present invention;

FIG. 3 is a schematic view of an embodiment of the present invention;

FIG. 4 is a schematic view of the tenon and structural element; and

FIG. 5 is a schematic view of the mortise and structural element.

### DETAILED DESCRIPTION OF THE INVENTION

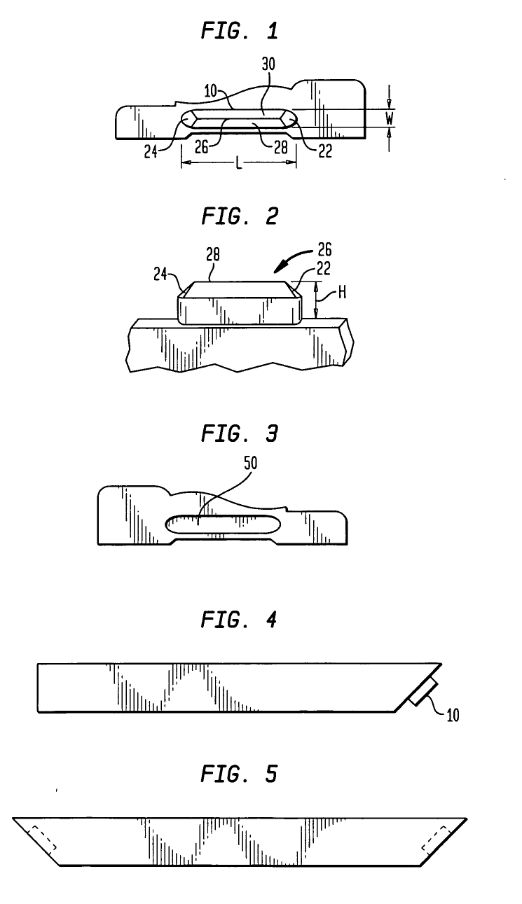

The present invention provides an improved mortise and tenon joint. In FIG. 1, a side view schematic of the tenon is depicted. In this embodiment, the tenon 10 is generally oval or oblong with two opposing ends 22, 24 and a center portion 26. The ends 22, 24 are shaped to extend in a slope upwards toward the center portion 26 as shown in FIG. 2. The center portion 26 comprises opposing sides 28,30 that slope up towards, and meet at, a middle 28. The tenon may be of other known shapes and is not limited to this preferred design.

The proper proportion between the overall length and height of the tendon compared to the overall size and shape of the structural element is generally known in the art. In the embodiment shown in FIG. 1, the size is approximately 31.75 mm in length and 4.76 mm in width and, as shown in FIG. 2, 12.7 mm in height. The size is generally determined by the structural elements being joined, which in this case are window or door mouldings. The constraints include but are not limited to the weight and shear forces acting on the joint as well as the amount of material available to form the mortise and tenon. These factors will help determine the dimensions (length, width, height) of the tenon.

FIG. 3 is a side plan view of the mortise 50 of the present invention. As is known in the art, the mortise is designed to generally correspond to the shape and size of the tenon, although they do not have to correspond exactly. In the example shown in FIG. 3, the mortise is oval or oblong and slightly larger in dimensions than the tenon, the walls do not slope and the bottom is planar. The size is intended to accommodate the tenon in a tight and close fitting joint. The joint is held together by both frictional forces, and the weight and shear forces acting on the joint from outside. The joint may also be fixed by adhesives or fasteners.

FIG. 4 shows the position of the tenon on the mitered edge of a moulding. The miter shown is a typical 45 degree corner but the corner may be of any angle. The tenon 10 height dimension is perpendicular to the mitered edge when the miter is a 45 degree miter. When the miter is anything else but a 45 degree angle, the tenon should be at an angle such that it will fit the mortise to form the final angle desired of the joined structural elements. This provides that the angle compensates for the angle of the mitered edge to form a 90 degree angle, but a 90 degree angle is not always necessary for the present invention. It might be desired that the structural elements form an angle less than or greater than 90 degree s.

FIG. 5 shows the preferred mortise embodiment. The structural element, in this case a moulding, has a mitered edge at a substantially 45 degree angle. The mortise is also perpendicular to this edge such that it joins well with an opposing tenon.

The embodiments shown in the present figures are mouldings intended for doors or windows, however, the tendon design is not limited to that use and can be used for other structural elements. The materials from which the joint of the present invention may be made include wood, plastic, concrete, rubber and other known building materials. It is preferred that the tenon be integral with the structural element however this is not necessary. For example, a mortise may be filed with a dowel or tenon element making the mortise a tenon.

Accordingly, it should be readily appreciated that the mortise and tenon joint of the present invention has many practical applications. Additionally, although the preferred embodiments have been illustrated and described, it will be obvious to those skilled in the art that various modifications can be made without departing from the spirit and scope of this invention. Such modifications are to be considered as included in the following claims.

1. A joint for securing structural elements together comprising:
a tenon on a mitered edge of a first structural element joined to an oppositely corresponding mortise on a mitered edge of a second structural element.

2. A joint as in claim 1 wherein:
the tenon has two opposing sloped side faces meeting at a center, and two opposing sloped end faces joining the side faces; and
the mortise oppositely corresponds to the tenon wherein the tenon closely fits to the mortise.

3. A joint as in claim 1 wherein:
the tenon has a glue relief on one side.

4. A joint as in claim 1 wherein:
the end faces of the tenon is tapered.

5. A joint as in claim 1 wherein:
the tenon is generally oval with two opposing ends, and a center portion.

6. A joint as in claim 5 wherein:
the ends are shaped to extend in a slope upwards toward the center portion.

7. A joint as in claim 5 wherein:
the center portion comprises opposing sides that slope up towards, and meet at a middle.

8. A joint as in claim 1 wherein:
the mortise is generally oval with non-sloping sides and a planar bottom to tightly fit the mortise.

9. A joint as in claim 1 wherein:
the mitered edge of the first structural element and mitered edge of the second structural element are both substantially 45 degree angles.

10. A joint as in claim 1 wherein:
structural element is a moulding.

11. A joint for securing structural elements together comprising a mortise and tenon wherein:
the mortise and tenon are formed on the mitered ends of two structural elements.

12. A joint for securing structural elements together as in claim 11 wherein:
the tenon has two opposing sloped side faces meeting at a center, and two opposing sloped end faces joining the side faces; and
the mortise oppositely corresponds to the tenon wherein the tenon closely fits to the mortise.

13. A joint for securing structural elements together as in claim 11 wherein:
the tenon has a glue relief on one side.

14. A joint for securing structural elements together as in claim 11 wherein:
the end faces of the tenon is tapered.

15. A joint for securing structural elements together as in claim 11 wherein:
the tenon is generally oval with two opposing ends, and a center portion.

16. A joint for securing structural elements together as in claim 15 wherein:
the ends are shaped to extend in a slope upwards toward the center portion.

17. A joint for securing structural elements together as in claim 15 wherein:
the center portion comprises opposing sides that slope up towards, and meet at a middle.

18. A joint for securing structural elements together as in claim 11 wherein:
the mortise is generally oval with non-sloping sides and a planar bottom to closely fit the mortise.

19. A joint for securing structural elements together as in claim 11 wherein:
the mitered edge of the first structural element and mitered edge of the second structural element are both substantially 45 degree angles.

20. A joint for securing structural elements together as in claim 11 wherein: structural element is a moulding.

21. A method of joining two structural elements comprising:
providing a tenon at the end of a first mitered structural element;
providing a mortise that oppositely corresponds to the tenon at the end of a second mitered structural element;
fitting the tenon into the mortise forming a tightly fitted joint between the first and second structural elements.

22. A method as in claim 21 wherein:
the mitered edge of the first structural element and mitered edge of the second structural element are both substantially 45 degree angles.

23. A method as in claim 21 wherein:
structural element is a moulding.
